(19) United States
(12) Patent Application Publication
(10) Pub. No.: US 2012/0251901 A1
(43) Pub. Date: Oct. 4, 2012

(54) FUEL CELL SYSTEM AND CORRESPONDING OPERATING PROCESS

(76) Inventors: Karsten REINERS, Esslingen (DE); Sven WENZEL, Aachen (DE)

(21) Appl. No.: 13/435,630

(22) Filed: Mar. 30, 2012

(30) Foreign Application Priority Data
Mar. 31, 2011 (DE) 10 2011 006 469.9

(51) Int. Cl. H01M 8/06; H01M 8/04

(52) U.S. Cl. 429/413; 429/423

(57) ABSTRACT

A fuel cell system (1), especially for motor vehicles, is provided with at least one fuel cell (2), which has at least two electrodes (3), to which at least one electric user (4) can be connected. The fuel cell system (1) has, furthermore, a reformer (9) as well as a fuel feed (13) for supplying the reformer (9) with fuel and/or an oxidant gas feed for supplying the reformer (9) with oxidant gas. The fuel cell (2), especially the electrodes (3), is/are protected if a temperature-measuring device (8) measures the electrode temperature of at least one of the electrodes (3) and if a control (24) sets a quantity of fuel fed to reformer (9) and/or a quantity of oxidant gas fed to reformer (9) depending on the measured electrode temperature.

### CROSS REFERENCE TO RELATED APPLICATIONS

This application claims the benefit of priority under 35 U.S.C. §119 of German Patent Application DE 10 2011 006 469.9 filed Mar. 31, 2011, the entire contents of which are incorporated herein by reference.

### FIELD OF THE INVENTION

The present invention pertains to a fuel cell system, especially of a motor vehicle.

The present invention pertains, furthermore, to a process for operating such a fuel cell system.

### BACKGROUND OF THE INVENTION

A fuel cell system usually has at least one fuel cell, which comprises at least two electrodes and an electrolyte. The two electrodes are called anode and cathode according to their functions and are separated by the electrolyte. The significance of fuel cells is that they convert chemical energy released during the chemical reaction of hydrogen and oxygen into electric energy. This electric energy can then be used by a user in the form of electric current for energy supply or stored. Mainly water is generated as the waste product by the chemical reactions that lead to a function of the fuel cell. This fact makes fuel cells an environmentally friendly type of energy generation. The educts for supplying the fuel cell are called cathode gas and anode gas according to the respective electrodes, to which they are fed. Air or a gas containing oxygen is usually used as cathode gas. As a rule, hydrogen or a gas containing hydrogen, which can be generated, for example, by means of a reformer from hydrocarbons, before it is fed as anode gas to the anode in the form of a reformate gas, is used as anode gas. High-temperature fuel cells, such as solid oxide fuel cells (SOFC from the English Solid Oxide Fuel Cell), usually have operating temperatures of a few hundred degrees Celsius. The fuel cell must therefore be brought to a corresponding temperature until the above chemical reactions start and the fuel cell delivers electric energy.

### SUMMARY OF THE INVENTION

An object of the present invention is to provide an improved or at least alternative embodiment, which is characterized especially by simplified handling, for a fuel cell system.

The present invention is based on the general idea of providing in a fuel cell system of the type mentioned in the introduction a temperature-measuring device, which measures an electrode temperature of at least one of the electrodes, and of using a control such that it sets a quantity of fuel fed to the reformer and/or a quantity of oxidant gas fed to the reformer depending on the measured electrode temperature. The control consequently sets a quantity of fuel or additionally a quantity of oxidant gas that is fed to the reformer especially depending on the electrode temperature.

The reformate gas has a carbon formation limit temperature, below which carbon is formed from the reformate gas. If the reformate gas reaches a surface that has a surface temperature that is lower than the carbon formation limit temperature, this leads especially to the formation of carbon on that surface. In case of fuel cells, the reformate gas is fed to an anode. If an anode temperature is lower than the carbon formation limit temperature, this leads to the formation of carbon on the anode surface. The consequence is especially a reduction in the performance of the anode, which may increase to the extent that the anode will become entirely unfit for use. The present invention utilizes the discovery that the carbon formation limit temperature can be reduced over broad temperature ranges, especially by varying the ratio of a fuel-oxidant gas mixture fed to the reformer. If it is possible to consistently maintain the carbon formation limit temperature below the anode temperature, the formation of carbon on the anode is interrupted or at least reduced. The variation of the quantity of fuel fed to the reformer and/or of the quantity of oxidant gas, which depends especially on the anode temperature, is therefore a useful and simple way of preventing carbon formation, especially on the anode.

Corresponding to an advantageous embodiment, the control can thus be designed and programmed such that it sets the quantity of fuel fed to the reformer and/or the quantity of oxidant gas fed to the reformer depending on the measured electrode temperature such that a fuel-to-oxidant ratio and hence a reformate gas is obtained, whose carbon formation limit temperature is below the electrode temperature, whereby especially the formation of carbon on the corresponding electrode is prevented or at least reduced. This can be embodied especially by the control setting the quantity of fuel and/or the quantity of oxidant gas corresponding to characteristics or characteristic diagrams assigned to the measured electrode temperature.

Corresponding to a possible embodiment of the solution according to the present invention, the control is coupled by a connection with the temperature-measuring device. The control has, furthermore, a connection with a fuel feed means and/or a connection with an oxidant gas feed means. The quantity of fuel fed by the fuel feed means to the reformer and/or the quantity of oxidant gas fed by the oxidant gas feed means to the reformer is varied by the control depending on the measured electrode temperature. This can be achieved especially by varying a capacity of the corresponding feed means, for example, the corresponding delivery means. For example, a pump, whose capacity is set by the control, may be used as a delivery means. The variation of the quantity of fuel fed to the reformate gas and/or the quantity of oxidant gas serves especially the purpose of avoiding or at least reducing the formation of carbon on the anode due to the reduction of the carbon formation limit temperature.

In another embodiment, the fuel cell system additionally has a recirculating means for returning anode waste gas to the reformer. The above-mentioned control or another control is connected to the recirculating means and designed such that it varies the quantity of anode waste gas returned to the reformer depending on the measured electrode temperature. This can be achieved especially by means of corresponding characteristics or characteristic diagrams or by adding to the existing characteristics or characteristic diagrams. The returning of the anode waste gas to the reformer may serve, for example, the purpose of maintaining the carbon formation limit temperature of the reformate gas below the measured electrode temperature, especially by varying the fuel-to-oxidant ratio. In addition or as an option, the quantity of anode waste gas returned to the reformer may depend on a reformate gas volume flow. The reformate gas volume flow can be taken into account especially by adapting the corresponding characteristics and characteristic diagrams, which are available to the control for varying the quantity of anode waste gas returned.

It should be pointed out that the connections between the control and the fuel feed means and/or the oxidant gas feed means or the temperature-measuring device as well as to the feed means mentioned below and the respective delivery means thereof do not necessarily consist of an electric conductor. In particular, wireless connections for transmitting the corresponding signals are conceivable as well. This also applies to connections between the controls, if a plurality of controls are present. It should, furthermore, be mentioned that the individual connections may also have a return channel, especially for polling the values of the individual components of the fuel cell system and for balancing same.

In another embodiment of the solution according to the present invention, the above-mentioned changes in the quantity of fuel returned to the reformer and/or in the quantity of oxidant gas fed to the reformer and/or in the quantity of anode waste gas returned to the reformer may additionally depend, each individually or together, on the conversion (conversion rate of anode gas and cathode gas) of at least one of the fuel cells. This can be embodied especially by means of corresponding characteristics or characteristic diagrams or by adapting the existing characteristics or characteristic diagrams. The taking into account of the conversion may serve especially the purpose of taking into account the quantity of fuel and/or the quantity of oxidant gas of the anode waste gas, which is/are returned to the reformer.

In an advantageous embodiment of the solution according to the present invention, the quantity of fuel fed to the reformer and/or the quantity of oxidant gas and/or the quantity of anode waste gas returned to the reformer are sent depending on the measured electrode temperature such that the resulting carbon formation limit temperature of the reformate gas is below the measured electrode temperature. This can be embodied especially by means of the above-mentioned characteristics or characteristic diagrams, or additional characteristics and characteristic diagrams, which are based on the measured electrode temperature in relationship to a ratio of the fuel-to-oxidant gas mixture, which is taken into account when feeding the quantity of fuel and/or the quantity of oxidant gas to the reformer and/or the quantity of anode waste gas fed to the reformer as well as the changes therein.

In another embodiment, water is fed to the reformate gas depending on the measured electrode temperature. Consequently, a quantity of water, which is added to the reformate gas, is varied, in particular, depending on the measured electrode temperature. This addition of water or the change in the quantity of water fed to the reformate gas serves especially the purpose of varying the carbon formation limit temperature and especially of maintaining it below the measured electrode temperature. The quantity of water fed to the reformate gas may be varied, in addition or as an alternative, depending on the reformate gas volume flow. This can serve especially the purpose of guaranteeing a percentage of water in the reformate gas for any desired reformate gas volume flows. In addition, the quantity of water fed to the reformate gas may depend on the conversion of at least one of the fuel cells.

In another embodiment, a quantity of anode waste gas returned to the reformate gas is changed depending on the measured electrode temperature. In addition or optionally, the quantity of anode waste gas returned to the reformate gas may be varied depending on the conversion (degree or rate of conversion of anode gas and cathode gas) of the respective fuel cell and/or the reformate gas volume flow. These changes serve especially the purpose of varying a carbon formation limit temperature of the reformate gas, preferably such that the carbon formation limit temperature is below the measured electrode temperature.

It should be noted that the water fed to the reformate gas may be in any state of aggregation. Consequently, it may be especially steam or liquid water. Furthermore, other liquids or gases containing water can lead to the same result.

The above-mentioned changes may take place in the respective embodiments each individually or together or in any desired combination continuously or in a stepped manner. In case of a stepped change, the respective step may be preset especially by the corresponding characteristics or characteristic diagrams. The changes may take place, furthermore, independently from each other or depending on each other. It is apparent that the individual changes may affect the carbon formation limit temperature and hence correspondingly the other variable parameters, which is taken correspondingly into account.

The above-mentioned changes may optionally take place only when the measured electrode temperature is above a preset minimum electrode temperature. As an alternative or in addition, the changes may take place only when the measured electrode temperature is below a preset maximum electrode temperature. Furthermore, corresponding minimum electrode temperatures and/or maximum electrode temperatures may be preset, each individually or together or in any desired combination, for the feeding of the quantity of fuel and/or of the quantity of oxidant gas to the reformer and for the feeding of water of reformate gas as well as returning anode waste gas to the reformer and/or to the reformate gas.

It should be pointed out that the determination of the electrode temperature by the temperature-measuring device does not necessarily have to take place directly at the respective electrode. Temperature determinations at any other desired points are also conceivable, if they make it possible to infer the corresponding electrode temperature. In particular, the temperature measurement of the electrode may take place in a contactless manner.

It is apparent that the above-mentioned features, which will also be explained below, can be used not only in the particular combination indicated, but in other combinations or alone as well, without going beyond the scope of the present invention.

Preferred exemplary embodiments of the present invention are shown in the drawings and will be explained in more detail in the following description, where the same reference numbers designate identical or similar or functionally identical components. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1 is a highly simplified schematic circuit diagram of a fuel cell system according to the present invention; and

FIG. 2 is a flow chart for explaining an operating process according to the present invention.

### DESCRIPTION OF THE PREFERRED EMBODIMENTS

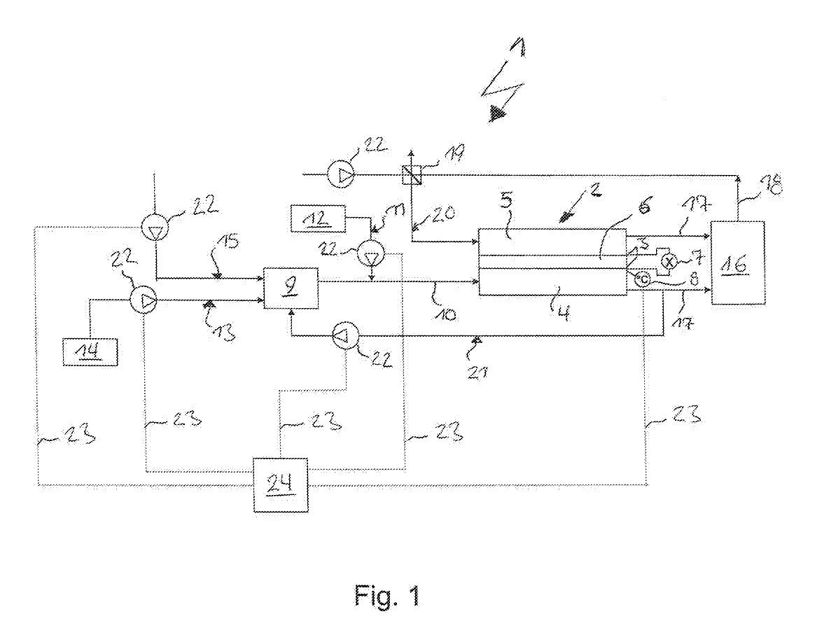

Referring to the drawings in particular, according to FIG. 1, a fuel cell system 1 comprises at least one fuel cell 2, which has at least two electrodes 3, namely, an anode 4 and a cathode 5, which are separated by an electrolyte 6. An electric user 7 is connected to the electrodes 3. The fuel cell system 1 has, furthermore, a temperature-measuring device 8, which is designed such that it can measure an electrode temperature of at least one of the electrodes 3, here an anode temperature of anode 4. Fuel cell system 1 has a reformer 9 for supplying the fuel cell 2 with reformate gas. The reformate gas is fed through a reformate gas line 10 to anode 4 of fuel cell 2. A water feed means 11 has a water container 12 and is connected to the reformate gas line 10 between reformer 9 and anode 4 such that the water feed means 11 can feed water to the reformate gas before entry into the fuel cell 2. The fuel cell system 1 has a fuel feed means 13 for supplying reformer 9 with a fuel, which said fuel feed means comprises a fuel container 14. Fuel cell system 1 has, furthermore, an oxidant gas feed means 15 for supplying reformer 9 with an oxidant gas. The fuel cell system 1 shown here additionally comprises a residual gas burner 16 for burning anode waste gas and cathode waste gas, said waste gases being fed through waste gas lines 17 to the residual gas burner 16. Residual gas burner 16 has a burner waste gas line 18, which is connected to a cathode gas feed means 20 in a heat-coupling manner, for example, by a heat exchanger 19. Fuel cell system 1 has, furthermore, a recirculating means 21 for returning the anode waste gas to reformer 9, where said recirculating means returns anode waste gas from the corresponding waste gas line 17 to reformer 9. Water feed means 11, fuel feed means 13, oxidant gas feed means 15, cathode gas feed means 20 and recirculating means 21 have each a delivery means 22, which is coupled with a control 24 by connections 23. Control 24 is connected, moreover, to the temperature-measuring device 8 by a connection 23.

Control 24 is equipped and programmed such that depending on the anode temperature of anode 4, which is measured by means of temperature-measuring device 8, it varies a quantity of fuel fed to reformer 9 and/or a quantity of oxidant gas fed to reformer 9. This can be implemented especially by varying the delivery capacity of the corresponding delivery means 22 of the fuel feed means 13 and of the oxidant gas feed means 15. Due to a corresponding programming and equipping, control 24 is, moreover, capable of varying a quantity of anode waste gas fed to reformer 9 depending on the anode temperature of anode 4, which is determined by temperature-measuring device 8. This change may be embodied especially by varying the capacity of the delivery means 22 of recirculating means 21. Control 24 is additionally programmed and equipped such that it is capable of varying a quantity of water, which is fed to the reformate gas before the latter enters fuel cell 2. This can be embodied especially by varying the capacity of delivery means 22 of water feed means 11. The individual changes and variations in the corresponding capacities of the delivery means 22 and hence the respective quantity of fuel fed, oxidant gas fed, quantity of anode waste gas and quantity of water or quantity of anode waste gas returned may take place independently or depending on one another. The delivery means 22 may, furthermore, be actuated individually or together or in any desired combination.

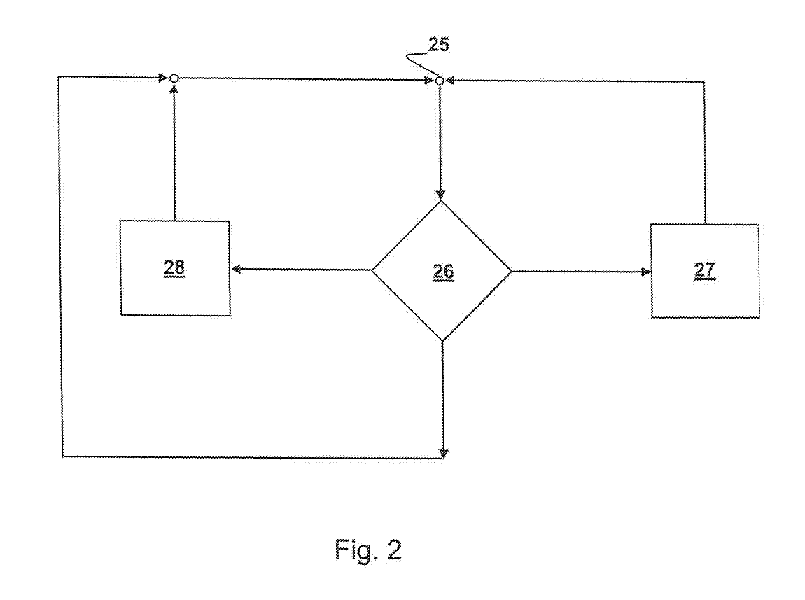

Control 24 may now be programmed, corresponding to an advantageous embodiment, such that it can embody the operating process described below on the basis of FIG. 2.

Starting from a starting point 25, the process checks the anode temperature of anode 4, which was measured by the temperature-measuring device 8 in a comparison section 26. If a reduction is detected compared to the anode temperature measured last, a quantity of fuel fed to the reformer 9 is reduced and/or a quantity of oxidant gas fed to reformer 9 is increased during an operation 27. The process then returns to starting point 25 and the process is repeated. However, if an increase in the anode temperature of anode 4 compared to the anode temperature measured last is detected in comparison section 26, the quantity of fuel fed to reformer 9 is increased and/or the quantity of oxidant gas fed to reformer 9 is reduced during an operation 28, and the process subsequently returns to starting point 25, after which the process is repeated. If the anode temperature of anode 4 is unchanged in comparison section 26, the process returns to the starting point 25 and the process is repeated. The change of the quantity of fuel fed to reformer 9 and/or of the quantity of oxidant gas fed to reformer 9 can now serve especially the purpose of lowering a carbon formation limit temperature of the reformate gas, below which carbon is formed from the reformate gas, to the extent that it is below the anode temperature. For example, a corresponding fuel-to-oxidant gas ratio can be assigned, for example, to an anode temperature of anode 4, especially in the form of characteristics and characteristic diagrams, and such a ratio is set in the corresponding operations.

Corresponding to the process, the return of anode waste gas to the reformer 9 can be additionally or alternatively varied, especially in operations 27 and 28. This step can be optionally carried out during operations following the operations 27 and 28. Control 24 now changes a quantity of anode waste gas fed to the reformer depending on the measured anode temperature of anode 4. This can be used to maintain the carbon formation limit temperature below the measured anode temperature, especially by fuel and/or oxidant gas possibly present in the anode waste gas.

In an alternative form of the process, control 24 additionally changes a quantity of water fed to the reformate gas, which quantity may additionally depend on a reformate gas volume flow. It is preferred here to increase the quantity of water fed to the reformate gas with decreasing anode temperature and/or with increasing reformate gas volume flow and to reduce it with rising anode temperature and/or decreasing reformate gas volume flow. This serves especially the purpose of maintaining the carbon formation limit temperature of the reformate gas below the anode temperature.

The process can, furthermore, take into account a minimum anode temperature of anode 4, with water being fed to the reformate gas only when the measured anode temperature of the anode is above the minimum anode temperature. This can serve especially the purpose of taking into account a minimum carbon formation limit temperature, below which a further reduction of the carbon formation limit temperature by feed water is not possible. As an alternative or in addition, the process can take into account a maximum anode temperature of anode 4, with water being fed to the reformate gas only when the measured anode temperature is below the maximum anode temperature. This can serve especially the purpose of taking into account anode temperatures that are above the carbon formation limit temperature of the reformate gas without the feed of water.

As an alternative to the above-mentioned process for changing the quantity of water fed to the reformate gas depending on the anode temperature and/or the reformate gas volume flow, a process is also advantageous in which a proportionate quantity of water to the quantity of reformate gas is assigned to each anode temperature or each anode temperature range. This can be embodied especially by characteristics or characteristic diagrams stored in control 24. Control 24 now changes the quantity of water fed to the reformate gas corresponding to the values stored in the characteristics or characteristic diagrams. These stored values may serve especially the purpose of maintaining the carbon formation limit temperature of the reformate gas below the measured anode temperature. The values may depend, furthermore, on the anode temperature and/or the reformate gas volume flow individually or together.

It should be pointed out that the process variants being described here as examples may alternatively or additionally depend on a cathode temperature of a cathode 5 without going beyond the scope of the present invention.

While specific embodiments of the invention have been shown and described in detail to illustrate the application of the principles of the invention, it will be understood that the invention may be embodied otherwise without departing from such principles.

What is claimed is:

1. A fuel cell system comprising:
at least one fuel cell with at least two electrodes for connecting at least one electric user;
at least one temperature-measuring device for measuring an electrode temperature, said at least one temperature-measuring device being correlated with a temperature prevailing at at least one of said electrodes or the measured electrode temperature corresponding to said temperature at at least one of said electrodes;
at least one reformer for generating a reformate gas for supplying said fuel cell;
at least one of a fuel feed means for feeding a fuel to said reformer and an oxidant gas feed means for feeding an oxidant gas to said reformer; and
a control setting a quantity of fuel fed to said reformer and/or a quantity of oxidant gas fed to said reformer depending on the measured electrode temperature.

2. A fuel cell system in accordance with claim 1, further comprising:
a recirculating means for recirculating anode waste gas from said fuel cell to said reformer, wherein said control sets a quantity of anode waste gas fed by said recirculating means to said reformer depending on the measured electrode temperature.

3. A fuel cell system in accordance with claim 2, wherein said control changes a quantity of anode waste gas fed by said recirculating means to said reformer depending on a reformate gas volume flow.

4. A fuel cell system in accordance with claim 1, wherein said control is designed and/or is programmed for the steps of:
controlling a quantity of fuel fed to the reformer and/or a quantity of oxidant gas fed to the reformer to set the quantity depending on an electrode temperature, which is correlated with a temperature prevailing at at least one of said electrodes or the measured electrode temperature corresponding to said temperature at at least one of said electrodes wherein a quantity of fuel fed to reformer and/or the quantity of oxidant gas fed to reformer and/or the quantity of anode waste gas fed to reformer is set such that a carbon formation limit temperature of the reformate gas is below the measured electrode temperature.

5. A process for operating a fuel cell system, the process comprising the steps of:
providing at least one fuel cell with at least two electrodes for connecting at least one electric user;
providing a reformer for generating a reformate gas;
providing a fuel cell feed means for feeding a fuel to the reformer and/or an oxidant gas feed means for feeding an oxidant gas to the reformer;
providing at least one temperature-measuring device for measuring an electrode temperature;
controlling a quantity of fuel fed to the reformer and/or a quantity of oxidant gas fed to the reformer to set the quantity depending on an electrode temperature, which is correlated with a temperature prevailing at least one of the electrodes or corresponds to this temperature.

6. A process in accordance with claim 5, wherein the quantity of fuel fed to the reformer and/or the quantity of oxidant gas fed is set depending on a conversion rate of fuel and/or oxidant gas at the fuel cell.

7. A process in accordance with claim 5, further comprising the step of providing a recirculating means for recirculating anode waste gas from the fuel cell to the reformer wherein a quantity of anode waste gas returned to the reformer is set depending on the electrode temperature.

8. A process in accordance with claim 5, further comprising the step of providing a recirculating means for recirculating anode waste gas from the fuel cell to the reformer wherein a quantity of anode waste gas fed to the reformer is set depending on a conversion of fuel and/or oxidant gas at the fuel cell.

9. A process in accordance with claim 5, wherein a quantity of fuel fed to reformer and/or the quantity of oxidant gas fed to reformer and/or the quantity of anode waste gas fed to reformer is set such that a carbon formation limit temperature of the reformate gas is below the measured electrode temperature.

10. A process in accordance with claim 5, wherein changes in a quantity in fuel fed to the reformer and/or in a quantity of oxidant gas fed to the reformer and/or in a quantity of anode waste gas fed to the reformer take place in a stepped manner or continuously.

11. A process in accordance with claim 5, wherein changes in a quantity of fuel fed to reformer and/or in a quantity of oxidant gas fed to the reformer and/or in a quantity of anode waste gas fed to the reformer take place depending on or independently from each other.

12. A process in accordance with claim 5, wherein a desired value is determined for a ratio of fuel to oxidant gas fed to the reformer on a basis of the measured electrode temperature, and said desired value is used as a basis for regulating a quantity of fuel fed to the reformer and/or a quantity of oxidant gas fed to the reformer and/or a quantity of anode waste gas returned to the reformer.

13. A process in accordance with claim 5, wherein a quantity of water fed to the reformate gas is set depending on the measured electrode temperature.

14. A process in accordance with claim 5, wherein a quantity of water fed to the reformate gas is set depending on a conversion of at least one of the respective fuel cells.

15. A process in accordance with claim 5, wherein a change in a quantity of water fed to the reformate gas takes place continuously or in a stepped manner.

16. A motor vehicle fuel cell system comprising:
a fuel cell comprising two electrodes with a motor vehicle user electrical connection;
a temperature-measuring device for measuring an electrode temperature correlated with a temperature prevailing at said electrodes or corresponding to a temperature at one of said electrodes;
a reformer for generating a reformate gas for supplying said fuel cell;
a fuel feed means for feeding a fuel to said reformer and an oxidant gas feed means for feeding an oxidant gas to said reformer; and
a control setting a quantity of fuel fed to said reformer and/or a quantity of oxidant gas fed to said reformer depending on the measured electrode temperature.

17. A motor vehicle fuel cell system in accordance with claim 16, wherein a quantity of fuel fed to the reformer and/or the quantity of oxidant gas fed is set by s said control depending on a conversion rate of fuel and/or oxidant gas at said fuel cell.

18. A motor vehicle fuel cell system in accordance with claim 16, further comprising a recirculating means for recirculating anode waste gas from the fuel cell to the reformer wherein a quantity of anode waste gas returned to the reformer is set by said control depending on at least one of:
the electrode temperature.
a conversion of fuel and/or oxidant gas at said fuel cell.

19. A motor vehicle fuel cell system in accordance with claim 16, wherein a quantity of fuel fed to reformer and/or the quantity of oxidant gas fed to reformer and/or the quantity of anode waste gas fed to reformer is set by said control such that a carbon formation limit temperature of the reformate gas is below the measured electrode temperature.

20. A motor vehicle fuel cell system in accordance with claim 16, wherein a desired value is determined for a ratio of fuel to oxidant gas fed to the reformer on a basis of the measured electrode temperature, and said desired value is used by said control as a basis for regulating a quantity of fuel fed to said reformer and/or a quantity of oxidant gas fed to said reformer and/or a quantity of anode waste gas returned to said reformer.

21. A motor vehicle fuel cell system in accordance with claim 16, wherein said control sets a quantity of water fed to the reformate gas depending on at least one of:
the measured electrode temperature; and
a conversion of fuel and/or oxidant gas at said fuel cell.
